(19) United States
(12) Patent Application Publication
(10) Pub. No.: US 2008/0238915 A1
(43) Pub. Date: Oct. 2, 2008

(54) SYSTEM AND METHOD FOR ACCELERATION OF COLLISION DETECTION

(76) Inventors: Jatin Chhugani, Santa Clara, CA (US); Jason Sewall, Chapel Hill, NC (US); Milkhail Smelyanskiy, San Francisco, CA (US)

Correspondence Address: SCHWEGMAN, LUNDBERG & WOESSNER, P.A., P.O. BOX 2938, MINNEAPOLIS, MN, 55402, US

(21) Appl. No.: 11/694,979

(22) Filed: Mar. 31, 2007

(51) Int. Cl. G06T 15/00

(52) U.S. Cl. 345/419

(57) ABSTRACT

One embodiment includes a method of pre-computing a support map which includes a run-time environment comprising at least one three dimensional convex body having a plurality of vertices on each of at least six sides, each side being divided into a predetermined number of sample regions. The embodiment includes determining, for each of at least six input directions, which of the plurality of vertices extends farthest from the body within each of the sample regions. The embodiment also includes storing resulting output data for each sample region in a memoization structure.

### TECHNICAL FIELD

Various embodiments described herein relate generally to systems and methods for managing shapes in a simulated environment, including a system and method for acceleration of collision detection.

### BACKGROUND

Cube maps are popular in graphics and have been used to memoize certain computations in the past (e.g., quickly normalizing vectors). However, the problem of deciding if a group of convex bodies are in contact with each other, known as convex collision detection, is resource intensive. The problem is made worse if the objects are discrete and highly tessellated.

### BRIEF DESCRIPTION OF THE DRAWINGS

FIG. 1 is a block diagram of a system according to various embodiments of the invention.

FIG. 2 is a flow diagram illustrating several methods according to various embodiments of the invention.

FIG. 3 is a flow diagram illustrating several methods according to various embodiments of the invention.

FIG. 4 is an illustration of an example collision detection computing system component.

FIG. 5 is an illustration of an example collision detection computing system component.

FIG. 6 is an illustration of an example collision detection computing system component.

FIG. 7 is a block diagram of an article according to various embodiments of the invention.

### DETAILED DESCRIPTION

The following detailed description is divided into four sections. The first section presents a system overview of the inventive subject matter. The second section provides methods of using example embodiments of the inventive subject matter. The third section describes example implementations. The fourth section describes the hardware and the operating environment in conjunction with which embodiments can be practiced.

The present subject matter is able to compute the support mapping of a convex object given a direction vector in constant time. Various examples apply memoization-based techniques to the problem of collision detection. Some examples accelerate collision detection via support map memoization. Various embodiments present one or more improvements (e.g., speed, power consumption) over methods which rely on O(n) methods or optimization and hierarchical methods that run in O(log n) time. For various embodiments, this results in an improvement in computation time for a number of algorithms, notably those used for collision detection.

One application for the present subject matter is in the context of game physics. In that application, as well as in other applications, the present subject matter achieves higher performance by using a texture unit. Various embodiments improve the usefulness of software development kits (SDK) which solve physics problems. Various embodiments add value to libraries and codebases which are used to develop software and hardware. Embodiments improve the speed of operation of collision detection algorithms on existing hardware, and can contribute to increased performance in future designs.

### System Level Overview

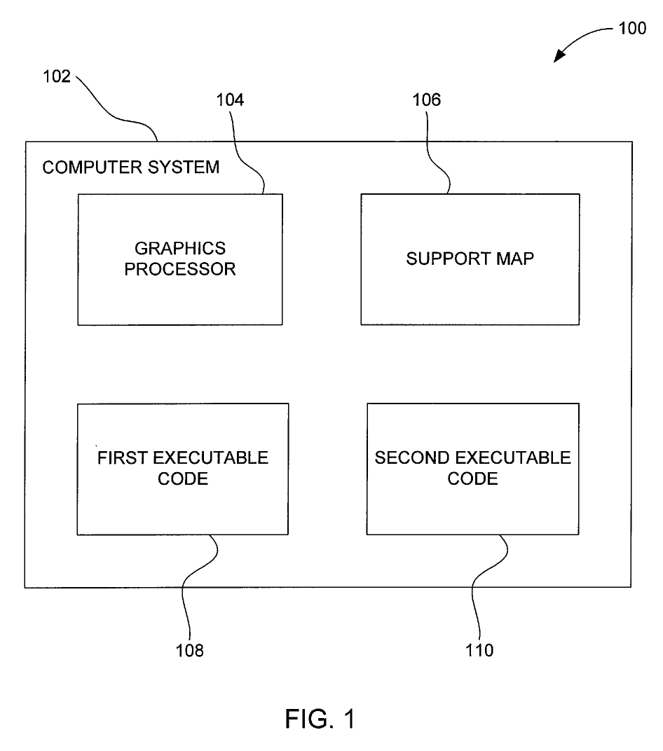

FIG. 1 comprises a block diagram 100 of computer system 102 for graphics. In various embodiments, the computer system 102 includes a graphics processor 104 to store values associated with a cube map representing a first object having a plurality of vertices. Some examples include a support map 106 representing which vertices of the first object have the greatest dot product with each of at least six input directions. Certain computer system 102 examples include a first executable code 108 to translate the support map values into associated cube map values to be stored. Some examples include a second executable code 110 to retrieve the support map values from the stored cube map.

In various embodiments, computers systems include a first executable code that is to translate the support map values into associated RGB-alpha values. Certain examples include a computer system by which the RGB-alpha values are to be stored in the cube map. Some examples include computer system by which the second executable code, in retrieving the associated RGB-alpha values from the cube map, is to translate the associated RGB-alpha values into associated support map values.

Some examples include a computer system by which the support map values are to be stored in a non-volatile memory. Examples contemplated include a computer system which includes a game physics engine to analyze the support map values in order to detect potential collisions between the vertices of the first object and one or more other objects. Some examples include a computer system by which the second executable code comprises a narrow phase collision detection algorithm. In various embodiments, the processor comprises a game physics engine.

### Methods

In this section, particular methods of example embodiments are described by reference to a flow chart. The methods to be performed constitute computer programs made up of computer-executable instructions.

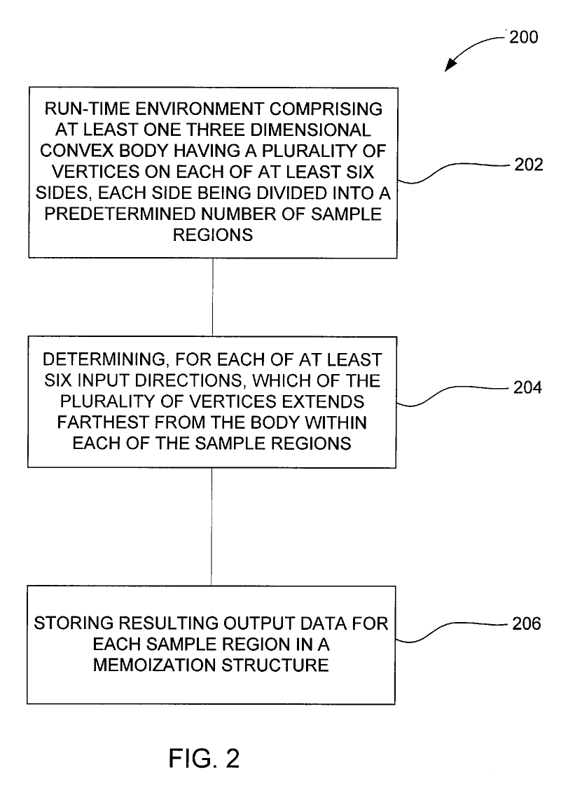

FIG. 2 is a flow diagram 200 illustrating several methods according to various embodiments of the invention. In various embodiment, the present subject matter provides a method at 202 of pre-computing a support map which includes a run-time environment comprising at least one three dimensional convex body having a plurality of vertices on each of at least six sides, each side being divided into a predetermined number of sample regions. In various examples, the method includes determining, at 204, for each of at least six input directions, which of the plurality of vertices extends farthest from the body within each of the sample regions. Certain examples include, at 206, storing resulting output data for each sample region in a memoization structure.

In various embodiments, the method of pre-computing a support map operates such that the predetermined number of sample regions on each of the at least six sides is to be determined by calculating an optimum number of sample regions based on the quantity and proximity of vertices on each of the at least six sides. In various embodiments, a method includes pre-computing a support map such that the output data for each sample region stored in the memoization structure is associated with a portion of a face of a cube map representing a support map associated with the convex body. Certain examples include a method of pre-computing a support map in which the run-time environment is a game, and wherein the output data is to be retrieved from the memoization structure to be used in a collision detection algorithm. Various examples include a method of pre-computing a support map in which the run-time environment is a simulation, and wherein the output data is to be retrieved from the memoization structure to be used in a collision detection algorithm.

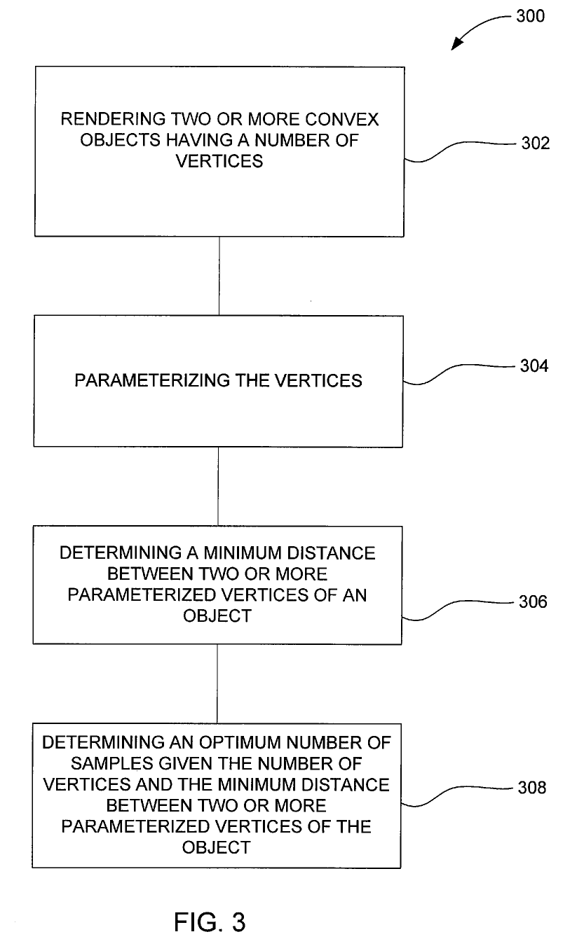

FIG. 3 is a flow diagram 300 illustrating several methods according to various embodiments of the invention. Various embodiments include a method of calculating a sampling parameter which includes rendering, at 302, two or more convex objects having a number of vertices. Certain examples include parameterizing, at 304, the vertices. Some examples include, at 306, determining a minimum distance between two or more parameterized vertices of an object. Some examples include, at 308, determining an optimum number of samples given the number of vertices and the minimum distance between two or more parameterized vertices of the object.

In various embodiments, the method is implemented in a run-time environment for a game. In some embodiments, the method is implemented in a run-time environment for a simulation. Various embodiments include a machine-accessible medium having associated instructions, wherein the instructions, when accessed, result in a machine performing one or more of the methods associated with FIG. 3.

It may be possible to execute the activities described herein in an order other than the order described. And, various activities described with respect to the methods identified herein can be executed in repetitive, serial, or parallel fashion.

### Example Implementations

Various examples of systems and methods for embodiments of the invention have been described above. This section illustrates various examples of procedures for the acceleration of collision detection.

This disclosure presents a method to improve the performance of an operation which is part of convex collision detection. Examples discussed herein replace a problem that is typically solved with an O(n) or O(log n) technique with one that runs in O(1) time, where n is the number of vertices in the colliding objects.

Various examples accelerate the “broad” phase of collision detection. Some examples accelerate the “narrow” phase of convex collision detection using sample-based memoization techniques.

In some embodiments, the broad phase of collision detection performs analysis on convex bodies to produce a “potentially colliding set” of pairs. One result of this phase is to reduce the size of a set of possible pairs of objects (n², for n bodies) to a set which is closer in size to the actual number of colliding pairs. Axis-aligned bounding boxes (AABBs) are frequently used to improve the speed of this phase.

Some embodiments include a narrow phase which performs tests on pairs of input bodies to determine if they truly collide. In various embodiments, the narrow phase is more accurate than the broad phase. Embodiments contemplated include, but are not limited to, the separating-axis test (SAT) and the Gilbert-Johnson-Keerthi algorithm (GJK).

The present subject matter provides a method and apparatus incorporating three components, in various embodiments. A first component uses a “cube map” memoization structure and an associated retrieval algorithm to compute a more exact support mapping of a convex object. In some embodiments, the first component computes in constant time. A second component includes an algorithm for generating a memoization structure from a discrete, convex body. In various embodiments, the second component provides reduced storage requirements. The third component uses a texture unit to accelerate one or more algorithms associated with the first and second components.

First Component

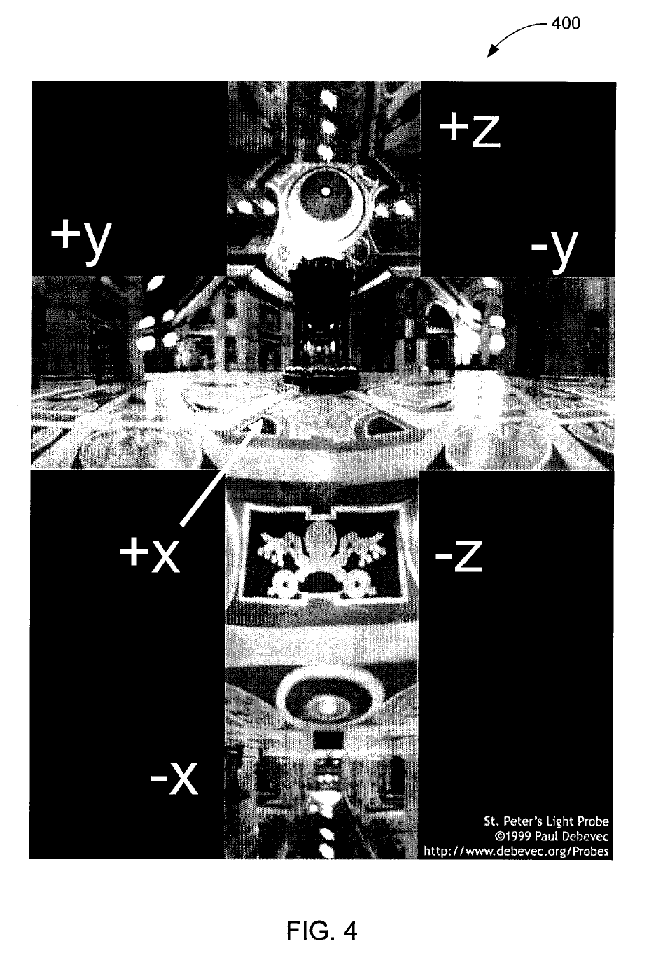

FIG. 4 is an illustration of an example collision detection computing system environment. The present subject matter maps one or more discrete, convex bodies in 3 dimensions from directions to points on the surface of the body. In some examples, the support mapping of an object A returns the vertex on A that has the greatest dot product with the input direction. The support mapping of A is the vertex on A that is “furthest along” (see, e.g., 400) in the input direction in various examples. In some examples, a plane perpendicular to the input vector is swept across the body along the input direction, and the last vertex intersected on A is the preferred support mapping for that direction.

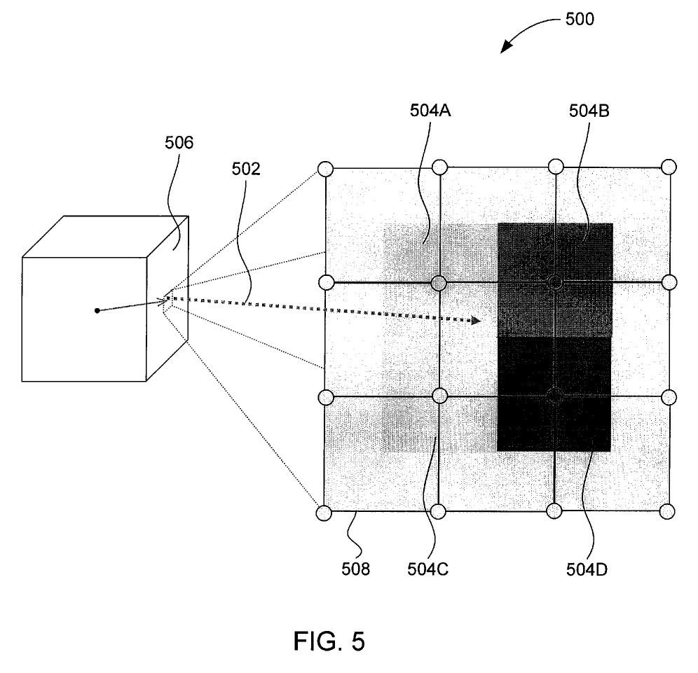

In some examples, the data structure is a sampled representation based on the cube map technique. Certain examples use a cube map to assign a color value to each direction. With a vector 502, some examples can determine which face 506 of the unit cube the vector points to, as well as parametric coordinates of that point on the face. As illustrated in example FIGS. 4-5, cube maps assign a regular grid 508 of samples (e.g. a texture) to each face and use interpolation to provide a color, 504A, 504B, 504C, . . . , 504D for a given direction. In the example shown in FIG. 5, 504A, 504B, 504C, . . . , 504D each represent a different color (e.g., 504A may be orange, 504B may be green, 504C may be blue, and 504D may be violet).

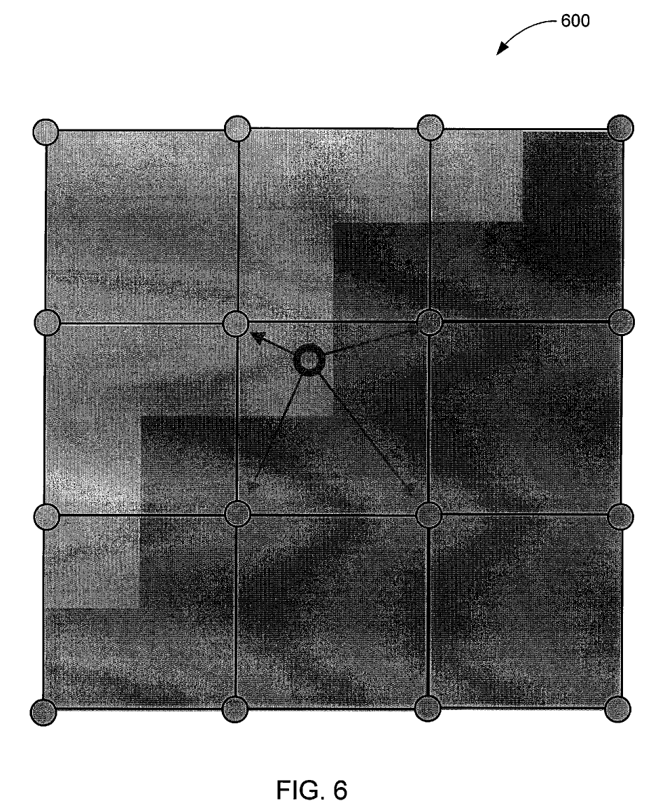

In various examples, such a cube map (e.g., one having nxn samples on each face) has positions of vertices stored rather than colors. In some of these embodiments, these positions correspond to the support mapping of a convex body for the nxn (e.g., ×6, for each face of the cube) discrete directions represented. Various examples return the support mapping for this object given a direction that maps directly to a sample. Various embodiments further process the directions that do not map to a sample. As illustrated in FIG. 6, one or more directions in the representation 600 will map to an edge, corner, or the interior of a square formed by 4 “nearby” samples.

In various embodiments, the correct support mapping of an object given a direction is one of the four nearest samples in the parameterization. Various examples compute the dot product of the original input direction with each nearest sample to recognize a sample with the greatest dot product.

Exemplary Pseudo-code for the Lookup Method

```
Vertex = compute_support(dir[3], cube_map c)
{
    Corner[0] = get_idx0(c, dir);
  Corner[1] = get_idx1(c, dir);
  Corner[2] = get_idx2(c, dir);
  Corner[3] = get_idx3(c, dir);
    Return Corner[i] [ i in [0..3] such that dot(Corner[i], dir) is
    maximal];
}
```

Second Component

Various lookup methods, such as the lookup method described above, rely on criteria established “by construction”. Various embodiments additionally determine the number of samples required. The present subject matter constructs a data structure given a convex body A and a sampling parameter n. In various embodiments, examples have n×n×6 directions, each with an associated sample that needs to be filled. Some examples compute the support mapping of A for each direction and store the results in the sample associated with the input direction.

Some examples seek the smallest sampling parameter n for which the cube map will have sufficient detail to accurately calculate the support mapping of an object for any direction. Some examples determine the minimum distance between the parameterized vertices of the object; the inverse of this minimum distance results in n.

Third Component

Lookup of the 4 corners can be accelerated using texture hardware capable of texture look-up. Such acceleration is independent of texture hardware.

The present subject matter can be used to improve the performance of a collision detection algorithm which relies on support mapping to retrieve geometric information about the convex bodies they are processing. Example collision detection algorithms include, but are not limited to, the following:

Broad phase collision: In some examples, the broad phase of collision detection is solved by a method known as “sweep-and-prune”. Some examples following using this solution technique examine the rough spatial relationships of the bodies in the scene and eliminate certain pairs from consideration for the narrow phase.

In various embodiments, an axis-aligned bounding box for one or more objects is computed. In various examples, this represents the furthest extents of the object along each axis. In some examples, the intervals covered by each object along each axis are considered and only those pairs of objects that overlap in all three projections are passed on to the narrow phase.

Various embodiments accelerate the computation of axis-aligned bounding boxes. Some examples rely on O(n) or O(log n) computations. Additional examples are able to find the extents of an object in a given direction in constant time. In various examples, the support mapping for a direction is computed and the point returned is projected onto a desired axis.

Narrow phase collision: Embodiments including narrow phase collision include one or more separate axis test convex collision detection algorithms which seek to find a direction (and the associated plane) that separates the pair of input objects. In various examples, this is done by projecting the extents of each object along that direction and comparing them. In some embodiments, this is repeated for a number of directions until a separating axis has been found or a suitable number of tests indicate collision.

Various embodiments improve the speed of this operation. Some embodiments return the extent of an object in any direction in constant time. Some examples do this for each direction and its opposite and project these points onto the direction vector.

The present subject matter includes embodiments which offer improved speed over a GJK algorithm based solution which uses support mapping directly to collect information about the relative positions of the objects. Some embodiments which include one or more GJK algorithms spend around 50-70% of their time computing support mappings. The present subject matter reduces the cost of these from O(n) to O(1). The present subject matter improves the speed of operation for other applications as well.

### Hardware and Operating Environment

This section provides an overview of an example hardware and the operating environments in conjunction with which embodiments of the inventive subject matter can be implemented.

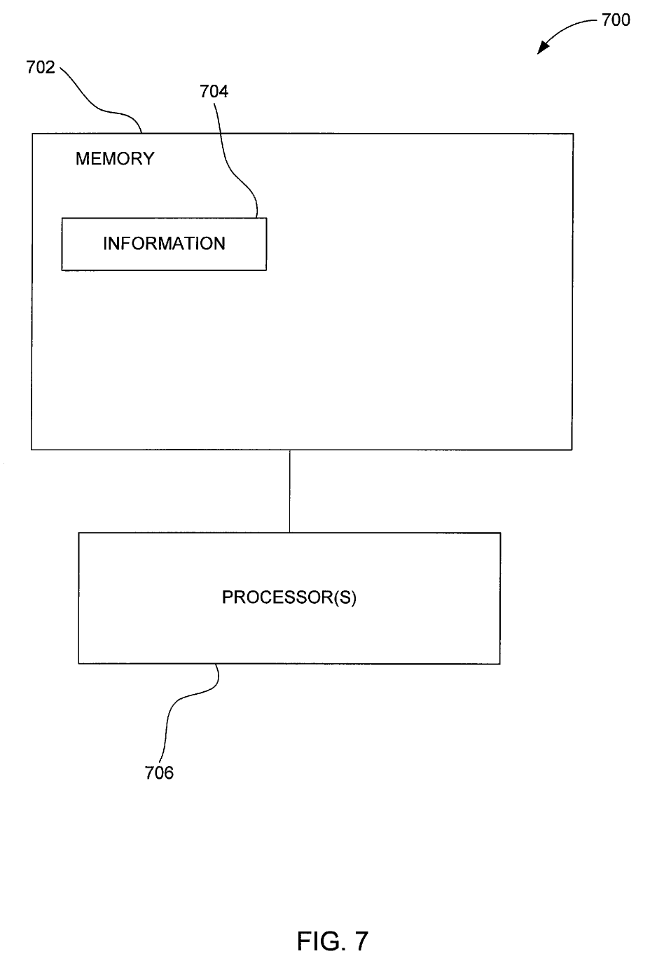

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 7 below.

FIG. 7 is a block diagram of an article 700 according to various embodiments of the invention. Such embodiments may comprise a computer, a memory system, a magnetic or optical disk, some other storage device, or any type of electronic device or system. The article 700 may include one or more processor(s) 706 coupled to a machine-accessible medium such as a memory 702 (e.g., a memory including electrical, optical, or electromagnetic elements). The medium may contain associated information 704 (e.g., computer program instructions, data, or both) which, when accessed, results in a machine (e.g., the processor(s) 706) performing the activities previously described herein.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which show by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

What is claimed is:

1. A method of pre-computing a support map comprising:
providing a run-time environment comprising at least one three dimensional convex body having a plurality of vertices on each of at least six sides, each side being divided into a predetermined number of sample regions;
determining, for each of at least six input directions, which of the plurality of vertices extends farthest from the body within each of the sample regions; and
storing resulting output data for each sample region in a memoization structure.

2. The method of pre-computing a support map of claim 1, wherein the predetermined number of sample regions on each of the at least six sides is to be determined by calculating an optimum number of sample regions based on the quantity and proximity of vertices on each of the at least six sides.

3. The method of pre-computing a support map of claim 1, wherein the output data for each sample region stored in the memoization structure is associated with a portion of a face of a cube map representing a support map associated with the convex body.

4. The method of pre-computing a support map of claim 1, wherein the run-time environment is a game, and wherein the output data is to be retrieved from the memoization structure to be used in a collision detection algorithm.

5. The method of pre-computing a support map of claim 1, wherein the run-time environment is a simulation, and wherein the output data is to be retrieved from the memoization structure to be used in a collision detection algorithm.

6. A computer system comprising:
a graphics processor to operate on values associated with a cube map representing a first object having a plurality of vertices;
a support map representing which vertices of the first object have the greatest dot product with each of at least six input directions;
a first executable code to translate the support map values into associated cube map values to be stored; and
a second executable code to retrieve the support map values from the stored cube map.

7. The computer system of claim 6, wherein:
the first executable code is to translate the support map values into associated RGB-alpha values;
wherein the RGB-alpha values are to be stored in the cube map; and
wherein the second executable code, in retrieving the associated RGB-alpha values from the cube map, is to translate the associated RGB-alpha values into associated support map values.

8. The computer system of claim 6, wherein the support map values are to be stored in a non-volatile memory.

9. The computer system of claim 6, and further comprising a game physics engine to analyze the support map values in order to detect potential collisions between the vertices of the first object and one or more other objects.

10. The computer system of claim 6, wherein the second executable code comprises a narrow phase collision detection algorithm.

11. The computer system of claim 6, wherein the processor comprises a game physics engine.

12. A method of calculating a sampling parameter comprising:
rendering two or more convex objects having a number of vertices;
parameterizing the vertices;
determining a minimum distance between two or more parameterized vertices of an object; and
determining an optimum number of samples given the number of vertices and the minimum distance between two or more parameterized vertices of the object.

13. The method of claim 12, wherein the method is implemented in a run-time environment for a game.

14. The method of claim 12, wherein the method is implemented in a run-time environment for a simulation.

15. A machine-accessible medium having associated instructions, wherein the instructions, when accessed, result in a machine performing the method of claim 12.
